(19) United States
(12) Patent Application Publication
(10) Pub. No.: US 2008/0013781 A1
(43) Pub. Date: Jan. 17, 2008

(54) HIGH-FREQUENCY DIAPHRAGM AND VOICE COIL ASSEMBLY

(76) Inventor: Anders Sagren, Uppsala (SE)

Correspondence Address: YOUNG & THOMPSON, 745 SOUTH 23RD STREET, 2ND FLOOR, ARLINGTON, VA, 22202, US

(21) Appl. No.: 11/775,358

(22) Filed: Jul. 10, 2007

Related U.S. Application Data
(60) Provisional application No. 60/830,095, filed on Jul. 12, 2006.

(51) Int. Cl. H04R 9/06

(52) U.S. Cl. 381/398

(57) ABSTRACT

A high frequency drive unit comprising a dome-type diaphragm in a diaphragm and voice coil assembly. The diaphragm and voice coil assembly is particular suitable for use in compound loudspeakers with a plurality of drive units adapted to reproduce different part of the audio frequency spectra and which drive units are arranged in a co-axial configuration. The diaphragm of the diaphragm and voice coil assembly according to the invention has a circular cut out at its top defining an inner periphery of the diaphragm dome. The diaphragm is suspended on its inner periphery by a top annular suspension, at the outer periphery by an outer annular suspension extending outwards in a radial direction and at the outer periphery by an inner annular suspension extending inwards.

### TECHNICAL FIELD OF THE INVENTION

The present invention relates electro-acoustic converters for sound reproduction, in particular, to loudspeaker high frequency drive units of dome-type and to compound loudspeakers with a plurality of drive units adapted to reproduce different part of the audio frequency spectra and which drive units are arranged in a co-axial configuration.

### BACKGROUND OF THE INVENTION

In most loudspeaker system for reproducing a larger part of the audio frequency spectra at least two drive units are used. An example being a woofer used for reproduction of sounds in the low frequency bands and a tweeter used for the high frequency bands. The voice coils of the separate drive units are via a cross-over filter network connected to a power amplifier, which provide the electrical signals representing the sound to be reproduced. The purpose of the cross-over filter is to provide each drive unit with electrical signals corresponding to the audio frequency range each drive unit is designed to reproduce. The characteristics of the filter are arranged so that around a cross -over frequency, in an intermediate band, the output to the woofer tails off with increasing frequency and the output to the tweeter tails off with decreasing frequency. The cross-over filter can for example be passive or active, digital or analogue. Careful matching of the characteristics of the filter with the characteristics of the drive units has to be undertaken to achieve good sound reproduction. The loudspeaker system may incorporate more than two drive units. A three way system with a tweeter, a mid range woofer and a woofer is a common loudspeaker construction. The matching cross-over filter will divided the electrical signal to the drive units having to characteristic cross-over frequencies and two intermediate bands.

The sound radiated from each of the drive units may be said to emanate from the apparent sound source or acoustic center of that unit; the position of the acoustic center is a function of the design of the particular drive unit an may typically be determined by acoustic measurements. In addition may the absolute position of the acoustic center be dependent on the frequency of the emitted sound. When separate loudspeaker drive units are used, such as in the common two- and three-way systems briefly described above, the acoustic centers will be physically displaced from each other. The drive units are usually mounted on a common baffle such that their acoustic centers lie in a common plane, but they are offset in a vertical direction in the plane of the baffle. For a listener positioned approximately in line with the axes of the loudspeaker drive units and approximately equidistant from the acoustic centers of both drive units, a desired balance of output from the two drive units can be obtained. However, if the position of the listener is moved from the equidistant position, the distances between the listener and the acoustic centers of the loudspeaker drive units will be different and hence sounds in the intermediate frequency bands produced by two drive units, will be received by the listener with a difference in time. This time difference between received sounds results in a phase difference between the sounds received at the listening position. The sounds from the two drive units no longer add together as intended in the intermediate band or bands; the resultant received sound will be disordered.

An area of particular interest are Public Announcement (PA) in for example auditoriums and concert halls. Modern premises are often constructed in a way that the room itself is virtually acoustically mute. Therefore, in order to keep the number of loudspeakers at a reasonable level, the system should comprises a number of high efficiency loudspeakers (high-Q loudspeakers). High-Q horns are commonly used. More problematic is to amplify sound in acoustically complex, non-mute, often older premises such as churches, theaters and concert halls. These reverberant halls are often constructed to amplify the human voice or the sound of instruments by a multitude of reflections of the sound waves in walls and ceilings. If conventional loudspeakers, with a phase difference between the different drive units, are used in such an environment, each reflection will double the phase difference. When the sound, after a multitude of reflections, reaches the listener it will be highly distorted. To damp the hall to obtain a near acoustic mute environment is in most cases not an attractive solution, since the acoustic character of for example a church is perceived as an essential part of the sound experience of such a premises.

A number of attempts have been made to overcome the undesirable effects originating from the displacement of the acoustic centers of the drive units. It is known to combine the low and high frequency loudspeaker drive units in a single compound co-axial construction. The compound co-axial loudspeaker drive unit consists of a generally conical low frequency diaphragm driven by a voice coil interacting with a magnetic structure that has a central pole extending through the voice coil. A high frequency diaphragm is positioned to the rear of the structure and sound output from this diaphragm is directed to the front of the loudspeaker drive unit by means of a horn structure extending co-axially through the center pole of the magnetic structure which interacts with the low frequency diaphragm. Thus both the low frequency and high frequency sounds are directed in a generally forward direction from the compound loudspeaker drive unit. In this co-axial form of loudspeaker construction there is no vertical or horizontal offset of the apparent sound sources for low and high frequencies. However the low frequency diaphragm is positioned at the front of the loudspeaker unit whereas the high frequency diaphragm is positioned at the rear of the loudspeaker unit and this results in relative displacement of the acoustic centers in the direction of the axis of the drive unit causing an undesirable time difference in the arrival, at the listener, of sounds from the high and low frequency diaphragms. More recent attempts are taught in for example U.S. Pat. Nos. 4,492,826 and 4,552,242 in which at least one smaller speaker is mounted co-axially above the larger speaker. Both share, to a non negligible degree, the drawback of the above-describe construction of having a relative displacement of the acoustic centers in the direction of the axis of the drive unit.

A compound loudspeaker drive unit with a low frequency unit and a high frequency unit with their acoustic center coinciding in all three dimensions is described in U.S. Pat. No. 5,548,657 and is commercially available. A miniature, but of conventional type, tweeter has been provided in a recess provided in the center pole piece of the woofer. Due to the miniaturization of the tweeter its efficiency will constitute a limitation. (Complex and costly methods of cooling, for example with ferrofluids, will be necessary in order to achieve an acceptable level of efficiency.) Although superior to previously described constructions, also this compound loudspeaker shows a phase difference that makes it less suitable for use in a multiple reflection environment. In addition, the teaching of U.S. Pat. No. 5,548,657, is limited to a compound loudspeaker that has two drive units, and is not applicable if three or more drive units are required.

In U.S. Pat. No. 6,912,292 a co-axial and co-planar compound drive unit is described. The magnetic circuit design, with permanent magnets having a radially extending magnetization directions, eliminates the need for miniature tweeters. In fact the described design makes it possible to make drive units with very high efficiency for the high frequency parts as well as the lower frequency parts. The U.S. Pat. No. 6,912,292 by the same inventor and applicant as the present invention, is hereby incorporated by references.

High frequency drive units, often referred to as tweeters, are available in a large variety. The today commonly used tweeters can roughly be categorized in three categories: dome tweeters, high frequency compression drivers and ribbon tweeters. The dome tweeters typically have a dome-shaped diaphragm with an diameter of a few centimeters. The dome is on its rim attached to the voice coil. The dome is made of a vibration damping material such as silk or an extremely light and rigid material such as titanium. A well designed dome tweeter can reproduce sound with good accuracy in the 2,000 Hz to 20,000 region. However, dome tweeters typically have a low efficiency (Q-value), and are sensitive to high loads as the dome-shape can result in uncontrolled vibrations, if a soft dome, or ringing, if a rigid dome, is used. The novel permanent magnet materials, for example neodymium-iron-boron, and novel designs of the magnetic circuits as described in U.S. Pat. No. 6,912,292 opens up for high efficiency dome tweeters. However, the sensitivity to high loads due to the described problems hinder full utilization of the advantages afforded by the novel magnetic materials and magnetic circuit designs, in applications requiring high sound levels.

Attempts have been made to address the poor efficiency of dome tweeters. One way is to combine the tweeter with a horn that better couples the high acoustic impedance of the drive unit to the lower impedance of the air. Horn tweeters of compression type can exhibit high efficiency, but typically to the expense of the accuracy in the sound reproduction.

Ribbon, or band, tweeters can be made to deliver high sound levels at a retained quality in reproduction accuracy. High quality ribbon tweeters are expensive.

Importantly, the elongated design, that is a result of the employed sound emitting elongated metal ribbon, makes the ribbon tweeter difficult, in practice impossible, to combine with the above described advantageous co-axial co-planar compound drive unit.

### SUMMARY OF THE INVENTION

One object of the present invention is to overcome the drawbacks of the prior art by providing a high frequency drive unit, or tweeter, having a high efficiency and which can be utilized in compound drive units with co-axially coinciding sound centers and preferably also co-planar sound centers.

The above-mentioned objects are achieved by the high frequency drive unit as defined in claim 1.

The loudspeaker drive unit according to the present invention is adapted for high frequency sound reproduction, and comprises a dome-shaped diaphragm and a support structure. The diaphragm is on its outer periphery connected to a voice coil, and has a circular cut out at its top defining an inner periphery of the diaphragm dome. The diaphragm is suspended at its inner periphery by a top annular suspension, at the outer periphery by an outer annular suspension extending outwards in a radial direction and at the outer periphery by an inner annular suspension extending inwards.

The diaphragm arrangement according to the invention ensure an accurate control of the dome. Vibrations will be well controlled and standing waves, which typically is a problem with soft domes, will be effectively canceled. Hence, the drive unit has the capability to facilitate sound reproduction with very low distortion. At the same time the suspensions allows for sufficient magnitude in the movements of the diaphragm in order to deliver high sound levels at reasonable input power, i.e. high efficiency.

One advantage afforded by the present invention is that the drive unit is well suited for being used in compound co-axial loudspeakers, in particular in compound co-axial and co-planar loudspeakers.

A further advantage is that the diaphragm, voice coil, and support structure can be arranged as a separate unit, easily detachable from the magnet circuit of the drive unit.

Embodiments of the invention are defined in the dependent claims. Other objects, advantages and novel features of the invention will become apparent from the following detailed description of the invention when considered in conjunction with the accompanying drawings and claims.

### BRIEF DESCRIPTION OF THE DRAWINGS

The invention will now be described in detail with reference to the drawing figures, in which

FIG. 1a schematically illustrates a cross sectional view of the magnetic circuits and the diaphragm arrangement according to the present invention;

FIG. 1b shows the top view of the diaphragm arrangement according to the present invention;

FIG. 2a-b schematically illustrates the use of the diaphragm arrangement according to the present invention in a three way loudspeaker compound drive unit.

### DETAILED DESCRIPTION OF THE INVENTION

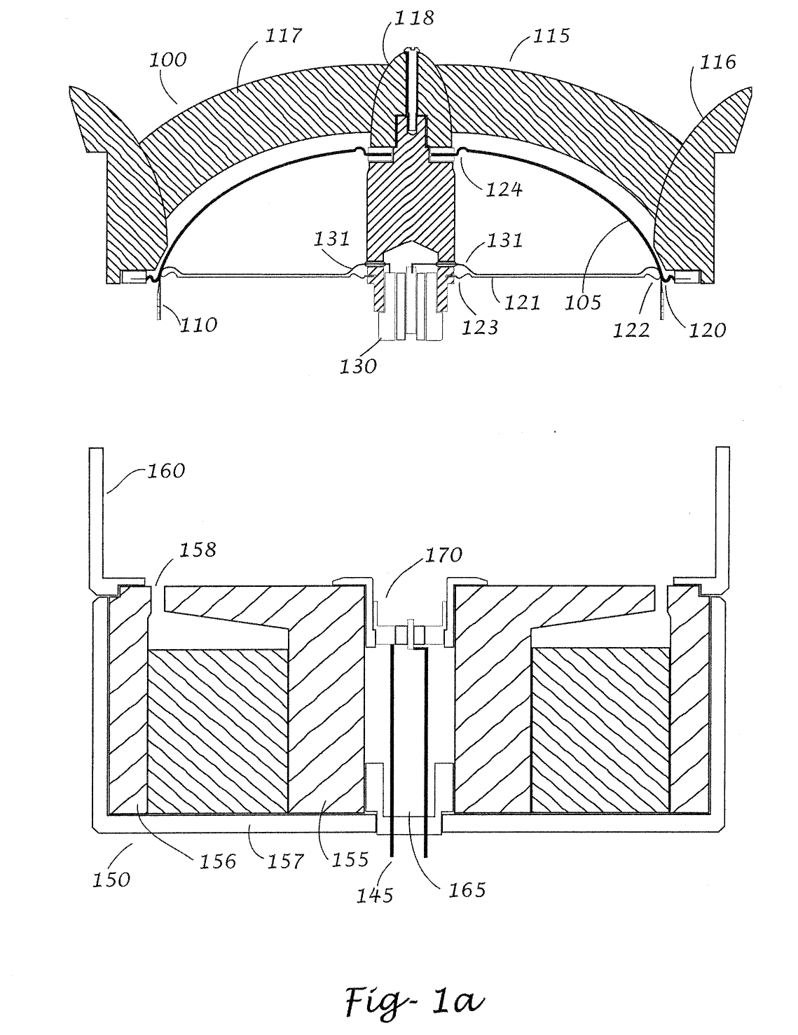

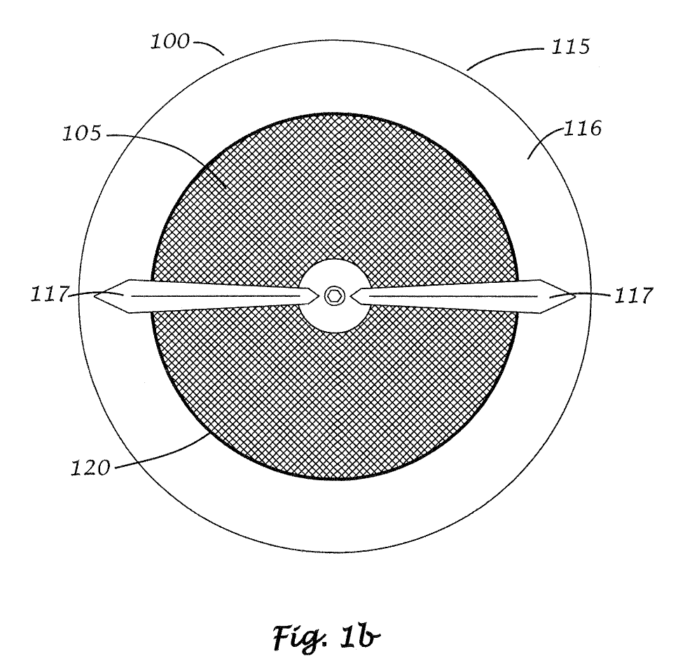

A first embodiment of the present invention will be described with reference to FIGS. 1a-d. The high frequency drive unit according to the invention comprises of a voice coil and diaphragm assembly 100 and a magnetic circuit assembly 150. Following the principles of U.S. Pat. No. 6,912,292 the two main parts, the voice coil and diaphragm assembly 105 and the magnetic circuit assembly 150 are separate modules and the voice coil and diaphragm assembly 105 is a self-supported module that can be removed and refitted to the magnetic circuit assembly 150.

The voice coil and diaphragm assembly 100 comprises a diaphragm 105, a voice coil 110 and a support structure 115. The support structure 115 comprises an annular part 116 defining the outer periphery of the voice coil and diaphragm assembly 100, and arranged to interact with a housing 160 of the magnetic circuit assembly 150. The support structure 115 is preferably formed to also serve as waveguide or a horn. This is indicated by the annular part 116 having an diameter that increases with the distance from the voice coil 110. At least one, preferable two or more radial girders 117 extends from the annular part 116 towards the center of the voice coil and diaphragm assembly 100. The girders 117 terminates in a center piece 118. The girders 117 are relatively thin, typically and preferably <5 mm, in the annular direction in order to not impede the sound wave transmission. The girders 117 may be extended, typically and preferably 10-20 mm, in the direction of the center axis of the drive unit in order to provide sufficient mechanical stability. As illustrated the centre piece may be formed of a plurality of parts for facilitating the mounting/demounting of the voice coil and diaphragm assembly 100. A cylindrical lower centre piece 119 may be joined, with a bolt 119, for example, to the center piece 118. Alternatively the center piece 118 is formed as one unit or the parts are permanently joined. The diaphragm 105 is essentially dome-shaped and provided with a centered circular cut out corresponding to the center piece 118. The diameter of the outer periphery should be in the order of 2-5 times the inner periphery. Particularly good result are achieved with the relation:
φₒᵤₜₑᵣ/π=φᵢₙₙₑᵣ, eq. 1

Wherein φₒᵤₜₑᵣ is the diameter of the outer periphery and φᵢₙₙₑᵣ is the diameter of the inner periphery.

At the outer rim the diaphragm is joined to a voice coil 110. Approximately at the junction between the diaphragm and the voice coil 110 an outer annular suspension 120 extending from the diaphragm 105 to the annular part 116 is provided to support the diaphragm and direct the voice coil in the pole gap. The windings of the voice coil 110 terminate in a electrical terminal 130, through which the current is fed. Attached on the inside, preferably at a position corresponding to the position of the outer annular suspension 120, is an inner annular suspension 121. The inner annular suspension 121 extends from the rim of the diaphragm 105 to the lower part of the center piece 118. The inner annular suspension 121 has a flexible section 122 adjacent to the diaphragm 105 and may have a second flexible section 123 providing the attachment to the center piece 118. In between, and to its major part, the inner annular suspension may be relatively rigid. The center cut out of the diaphragm 105 is via a top annular suspension 124 attached to a upper part of the center piece 118. The three suspensions, the outer annular suspension 120, the inner annular suspension 121 and the top annular suspension 124, ensure an accurate control of the dome. Vibrations will be well controlled and standing waves, which typically is a problem with soft domes, will be effectively canceled. Hence, the voice coil and diaphragm assembly 100 has the capability to facilitate sound reproduction with very low distortion. At the same time the suspensions allows for sufficient magnitude in the movements of the diaphragm in order to deliver high sound levels at reasonable input power, i.e. high efficiency. Suitable materials for the support structure are plastic or metal. The diaphragm is preferably of a semi-rigid material such as reinforced cloth or a light and thin metal. The flexible sections of the suspensions are preferable made of a flexible and mouldable rubber-like material such as silicone or urethane. Alternatively the flexible sections are made of the same material as t he diaphragm and coated with a moulding of silicone or urethane, for example, to prevent resonances. The mentioned materials are commercially available and known to the person skilled in the art. The skilled person would also be able to substitute the mentioned materials with other materials used for loudspeakers.

The voice coil and diaphragm assembly 100 according to the invention is adapted to engage and interact with a magnetic circuit assembly 150. The magnetic circuit assembly 150 comprises a housing 160 which inner and outer pole piece 155, 156 and the permanent magnet 157. The housing 160 is arranged to guide, and to provide accurate positioning, of the voice coil and diaphragm assembly 100. The pole pieces 155, 156 forms a pole gap 158 which is adapted to receive the voice coil 110 of the voice coil and diaphragm assembly 100. The magnetic circuit assembly 150 is provided with an electrical terminal 170 adapted to mate with the electrical terminal 130 of the voice coil and diaphragm assembly 100.

According to one embodiment of the invention an electrical terminal 130 for the electrical connection of the voice coil 105 is arranged in the centre of the voice coil and diaphragm assembly 100, beneath, and supported, by center piece 118. The electrical terminal extends below the plane defined by the inner annular suspension 121 and is adapted to mate with an electrical terminal recessed in the magnetic circuit. Alternatively the electrical terminal 130 may extend upwards into a center cut out of the center piece 118, in which case the mating part of the electrical terminal, arranged on the magnetic circuit assembly 150, protrudes from the upper surface of the magnetic circuit. Electrical leads 131 connect the voice coil 105 to the electrical terminal 130. The electrical terminal 130 and the mating electrical terminal 170 are preferably two pole coaxial connectors, not sensitive to rotation, with one center-terminal and one outer circular terminal. The mating electrical terminal 170 of the magnetic circuit assembly is preferably provided in a center bore 165 of the inner pole piece 155. Electrical leads 145, for external connection to the mating electrical terminal 170, are provided via the center bore 165.

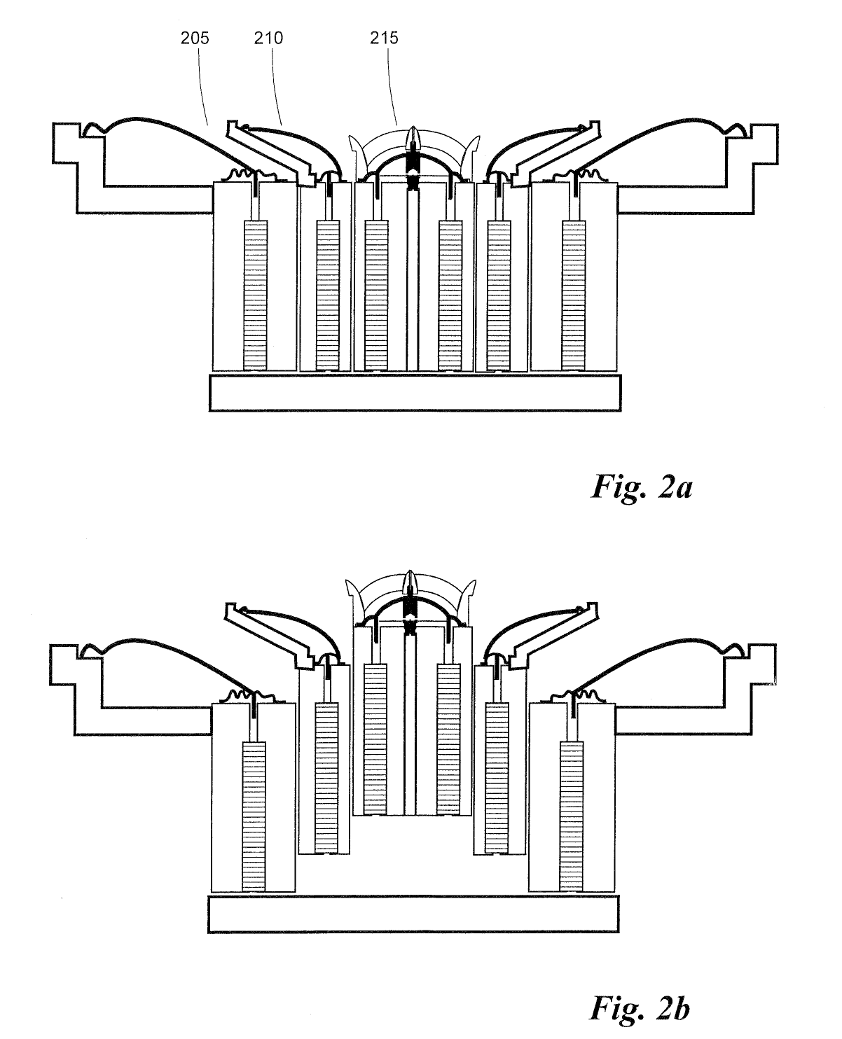

The voice coil and diaphragm assembly 100 according to the present invention is particularly suitable to use in the co-planar and co-axial compound loudspeaker described in the above referred U.S. Pat. No. 6,912,292. Such compound drive unit comprises a high frequency drive unit and at least one further drive unit, a low frequency drive unit. Illustrated in FIG. 2a-b is a compound drive unit 200 comprising of a low frequency drive unit 205, a mid range frequency drive unit 210 and a high frequency drive unit 215. Each individual drive unit comprises a magnetic circuit assembly and a voice coil and diaphragm assembly. As indicated in FIG. 2b the individual drive units are completely separate units that can be demounted and remounted independently. Each voice coil and diaphragm assembly is detachable from respective magnetic circuit as separate units, in the same manner as described above. The high frequency drive unit 215 comprises the voice coil and diaphragm assembly 100 according to the invention. As the voice coil and diaphragm assembly 100 can be made small enough to comply with the co-planar and co-axial arrangement, and is capable of reproducing high sound levels without significant distortion, full advantage can be taken of the compound drive units efficiency.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

1. A loudspeaker drive unit adapted for high frequency sound reproduction, the drive unit comprises a support structure, a voice coil and a dome-shaped diaphragm which on its outer periphery is connected to the voice coil, wherein the diaphragm has a circular cut out at its top defining an inner periphery of the diaphragm dome, and the diaphragm is suspended at its inner periphery by a top annular suspension, at the outer periphery by an outer annular suspension extending outwards in a radial direction and at the outer periphery by an inner annular suspension extending inwards.

2. The loudspeaker drive unit according to claim 1, wherein the top annular suspension is fixed to a center piece of the support structure, the center piece extending through the diaphragm at least to a plane defined by the inner annular suspension.

3. The loudspeaker drive unit according to claim 2, wherein the inner annular suspension is on its inner periphery fixed to the center piece of the support structure.

4. The loudspeaker drive unit according to claim 1, wherein the center cut out is circular and has a diameter which is at least three times smaller than the diameter of the outer periphery of the diaphragm.

5. The loudspeaker drive unit according to claim 1, wherein the center piece of the support structure is on the side adapted to face the magnetic circuit, provided with an electrical terminal which is in connection with the windings of the voice coil.

6. The loudspeaker drive unit according to claim 1, wherein the support structure has an annular part, which on its outside is arranged to provide a close fitting to a housing of a magnetic circuit assembly.

7. The loudspeaker drive unit according to claim 1, wherein the support structure has an annular part, which on its inside has an diameter that increases with the distances from the voice coil.

8. The loudspeaker drive unit according to claim 7, wherein the support structure has an annular part, which on its inside forms a waveguide.

9. The loudspeaker drive unit according to claim 7, wherein the support structure has an annular part, which on its inside forms an acoustical horn.
